(19) United States
(12) Patent Application Publication
(10) Pub. No.: US 2017/0150856 A1
(43) Pub. Date: Jun. 1, 2017

(54) Extendable Window Cleaner with Linear Actuator

(71) Applicant: Melvin C. Faler, JR., Lancaster, PA (US)

(72) Inventor: Melvin C. Faler, JR., Lancaster, PA (US)

(21) Appl. No.: 15/359,394

(22) Filed: Nov. 22, 2016

Related U.S. Application Data
(60) Provisional application No. 62/261,443, filed on Dec. 1, 2015.

(51) Int. Cl. A47L 1/15; B08B 3/04; B08B 1/00

(52) U.S. Cl. CPC A47L 1/15; B08B 1/002; B08B 1/006; B08B 3/04

(57) ABSTRACT

A window washing pole system incorporates a linear actuator that causes the washing head to move in a reciprocating manner to provide a scrubbing action for the washing of windows at a height above the operator's head. A standard extendable window washing pole system in which extensions can be added to vary the length of the apparatus, and thus the height the apparatus will reach, is adapted to be connected to the distal end of a linear actuator, or the actuator is incorporated into the proximal end of the pole system, and operable on compressed air to provide the reciprocating action for the washing head. Supply lines for delivering washing solution to the washing head can still be utilized. Controls for operating the linear actuator can be provided to enable the washing head to be operating in a scrubbing mode or in other modes, such as a squeegee operating mode.

### CROSS-REFERENCE TO RELATED APPLICATIONS

This application claims domestic priority on U.S. Provisional Patent Application Ser. No. 62/261,443, filed on Dec. 1, 2015, the content of which is incorporated herein by reference.

### FIELD OF THE INVENTION

This invention relates generally to a hand held device for washing windows or other structure and, more particularly, to a window washing apparatus that incorporates an internal linear actuator to move the washing head of a pole system in a reciprocal manner to cause the washing head to scrub against the window without the operator exerting effort to make the washing head move vertically.

### BACKGROUND OF THE INVENTION

The service industry for cleaning building structure, particularly windows, that are out of reach by a worker standing on the base reference, such as the ground or the floor of a building, have utilized ladders to enable the worker to be elevated in order to reach the higher windows, or other structure being cleaned. The use of ladders requires relocation of the ladder for each window to be cleaned, and also introduces a risk factor of falling from the ladder, or the ladder failing structurally, resulting in injury to the worker utilizing the ladder. Other mechanisms have been incorporated into the building structures to lower workers from the roof of the structure to enable the workers to reach the elevated windows or other building structure. Again, a risk of falling or structural failure of the mechanism is present.

For windows that are not extraordinarily high, extendable pole systems have been created to allow the worker to reach the elevated windows. Such devices incorporate a washing head having lines associated therewith to provide a source of water and cleaning solution to the washing head for application to the window as the washing head is moved to scrub against the window. Such pole systems have elongated handles that are usually manufactured in modules that can be coupled together to allow the washing head to be located as much as fifty or sixty feet above the worker's head. Adding additional handle modules to the washing device increases the weight of the washing device that has to be placed into a generally vertical orientation and then supported in that orientation by the worker to be moved manually in a vertically reciprocal manner needed to scrub the washing head against the window being cleaned. The extended pole system can have significant weight that rapidly tires the worker supporting and moving the washing device to clean elevated windows.

It would be desirable to provide a window washing device in which the operator of the washing device is not required to manually move the washing head in a vertically reciprocal manner in order to provide a scrubbing action for the elevated windows. It would be further desirable to provide a window washing device in which the operator need only support in a substantially vertical orientation while standing on a base reference, such as the ground or the floor of a building structure.

It would also be desirable to provide a device that can be coupled to a conventional pole system to assist in the vertically reciprocal movement of the elevated washing head, or incorporated into the pole system at the time of manufacture.

### SUMMARY OF THE INVENTION

It is an object of this invention to overcome the disadvantages of the prior art by providing an extendable window washing device that incorporates a reciprocating linear actuator to move the washing head.

It would be another object of this invention to incorporate a reciprocating linear actuator adapter onto an extendable window washing pole system that will move the washing head without requiring the worker holding the window washing apparatus to manually move the entire window washing apparatus.

It would be another object of this invention to incorporate a reciprocating linear actuator into the structure of a pole system to improve the operational efficiency of the pole system in washing elevated windows.

It is a feature of this invention that the person holding a window washing pole system configured to reach windows at a height above the person's head is not required to move the entire window washing pole system vertically reciprocal manner in order to wash the windows.

It is an advantage of this invention that the person holding a window washing apparatus configured to reach heights above the person's head is less fatigued by the process of washing windows at a height above the person's head.

It is another feature of this invention that the standard extendable window washing pole system can be connected to the end of a linear actuator adapter that is held by the operator to wash windows at heights above the operator's head.

It is another advantage of this invention that the linear actuator causing the reciprocal movement of the washing head is located in the hands of the operator to maintain stability for the window washing apparatus.

It is still another feature of this invention that the linear actuator can be operated with a source of compressed air to provide the power for reciprocating the window washing apparatus.

It is yet another feature of this invention that the linear actuator can be either a single acting or double acting cylinder, wherein the weight of the window washing apparatus can compress the linear actuator when in the single acting configuration.

It is still another advantage of this invention that an air compressor will provide the operative power for reciprocating the window washing apparatus without requiring access to the facilities of the building being cleaned.

It is still another feature of this invention that a supply of cleaning solution for the window washing apparatus can be delivered to the washing head while the window washing apparatus is being operated in a reciprocating manner.

It is a further object of this invention to provide an apparatus for washing windows at a height above the worker's head that is durable in construction, inexpensive of manufacture, carefree of maintenance, facile in assemblage, simple and effective in use.

These and other objects, features and advantages are accomplished according to the instant invention by providing a window washing pole system that incorporates a linear actuator to cause the washing head to move in a reciprocating manner and provide a scrubbing action for the washing of windows at a height above the operator's head. A standard extendable window washing pole system in which extensions can be added to vary the length of the apparatus, and thus the height the apparatus will reach, is adapted to be connected to the distal end of a linear actuator, or the actuator is incorporated into the proximal end of the pole system, and operable on compressed air to provide the reciprocating action for the washing head. Supply lines for delivering washing solution to the washing head can still be utilized. Controls for operating the linear actuator can be provided to enable the washing head to be operating in a scrubbing mode or in other modes, such as a squeegee operating mode.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a front elevational view of a window washing device incorporating the principles of the instant invention, the washing head being a brush mounted on the distal end of a handle with the actuator member connected to the proximal end of the handle;

FIG. 2 is a side elevational view of the window washing device shown in FIG. 1;

FIG. 3 is a rear elevational view of the window washing device shown in FIG. 1;

FIG. 4 is a cross-sectional view of the actuator member connected to the proximal end of the handle of the washing device, corresponding to lines 4-4 of FIG. 2, the linear actuator being shown in a retracted position;

FIG. 5 is a cross-sectional view of the actuator member similar to that of FIG. 4, except that the linear actuator has been extended to the extended position;

FIG. 6 is an enlarged cross-sectional view of the adapter fitting at the distal end of the actuator member, corresponding to circle 6 in FIG. 4;

FIG. 7 is an enlarged cross-sectional view of a central portion of the actuator member corresponding to circle 7 to show the distal fitting for the linear actuator within the actuator member; and

FIG. 8 is an enlarged cross-sectional view of the proximal end of the actuator member corresponding to circle 8 to show the base fitting for the linear actuator within the actuator member.

### DETAILED DESCRIPTION OF THE PREFERRED EMBODIMENTS

Referring now to drawings, a window washing pole system incorporating the principles of the instant invention can best be seen. The window washing pole system 10 includes a washing head 15 mounted on the distal end of a telescopic handle 13 to position the washing head 15 at a location that is typically elevated beyond the normal reach of the operator using the window washing pole system 10. The washing head 15 is depicted as a brush, but one of ordinary skill in the art will recognize that the washing head 15 can take one of several different configurations, including a squeegee or a cloth member, so long as the purpose of engaging the surface of the window to clean the window can be accomplished. Furthermore, one of ordinary skill in the art will recognize that the drawings can reflect a first configuration of the instant invention where the linear actuator is a separate adapter that can be coupled onto the proximal end of the conventional pole system, or another configuration in which the linear actuator is incorporated into the proximal end of the structure of the pole system at the time of original manufacture.

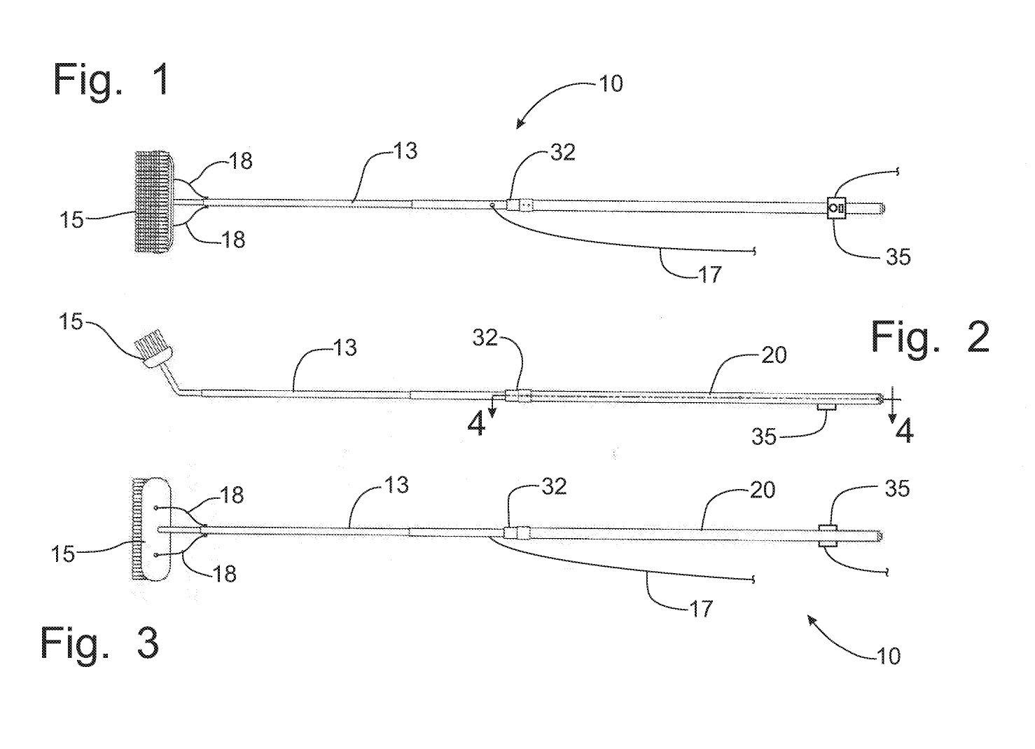

Typically, the window washing pole system 10 is provided with supply lines 17 that deliver water and/or a cleaning solution to the washing head 15 for application to the surface of the window in conjunction with the engagement of the washing head 15 to scrub and clean the surface of the window. Exemplary supply lines 17 are depicted in the FIGS. 1-3 as being carried internally of the telescopic handle 13 with a pair of delivery lines 18 delivering water and/or cleaning solution directly to the washing head 15, and the supply line exiting the proximal end of the telescopic handle 13 to connect to a supply of water and/or cleaning solution on the ground. One skilled in the art will further recognize that these supply lines could be carried externally of the handle 13 so long as sufficient slack is provided for the extension of the telescopic handle.

The washing head 15, supply lines 17, 18 and the telescopic handle 13 are commercially available components that can be purchased from a number of suppliers for which the handles 13 can be provided in a number of different configurations. For the purposes of the instant invention, any of these commercially available washing heads 15 and handles 13 can be utilized in association with the actuator member 20, which would form an adapter to the conventional pole system, according to the principles of the instant invention. The primary differences in utilizing the adapter actuator member 20 will lie in the manner in which the handle 13 is connected to the actuator member 20. Some handles 13 are telescopic, others are in modular form and the proximal ends thereof can be configured with threads to screw into a second handle, or in the instant invention to the actuator member 20. The number of handles 13 connected to one another and, ultimately, to the washing head 15, depends on the height of the window (or other appropriate building structure) to be cleaned. As an alternative, the actuator member 20 can be built into the structure of the pole system 10 at the time of manufacture to provide an integral actuator member 20, operable in the same manner as described below with respect to the adapter configuration.

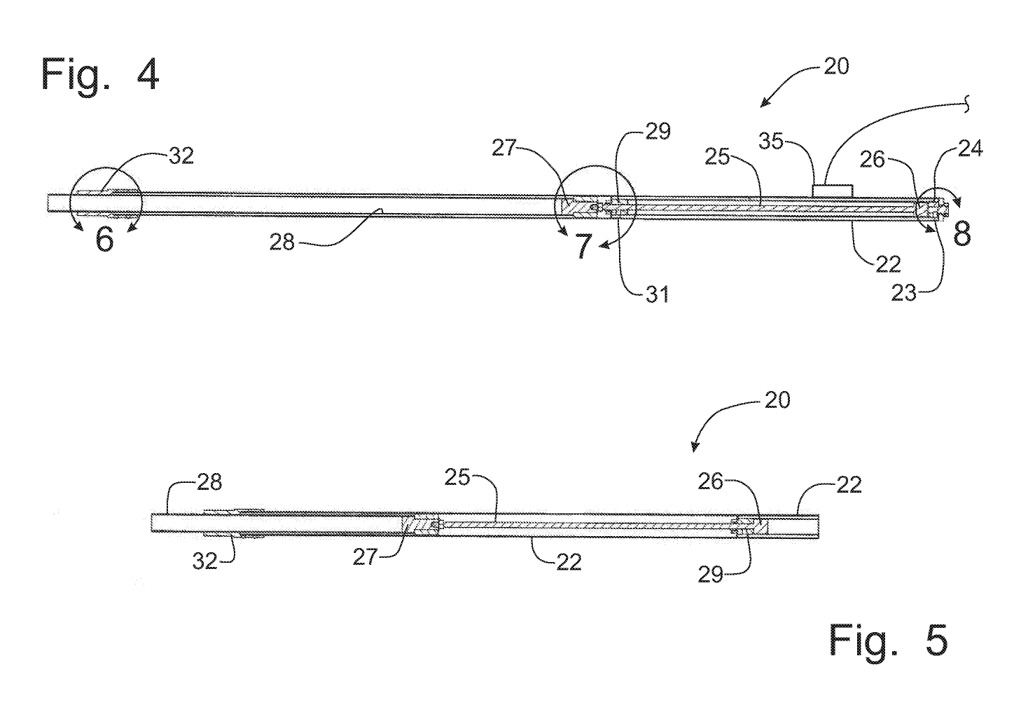

The actuator member 20 is best seen in cross-section in FIGS. 4 and 5. The actuator member 20 includes an internal linear actuator 22, which is preferably in the form of a pneumatic cylinder. One skilled in the art will recognize that the linear actuator 22 could take other forms, including a hydraulic cylinder, operated with fluid rather than air, or an electric screw device. The pneumatic cylinder 22 is preferable because of the lightweight configuration thereof. Hydraulic cylinders would be significantly heavier than a pneumatic cylinder and carries a risk of leaking hydraulic fluid, which could be heated through the operation of the hydraulic cylinder and cause injury to the operator. Electrically powered screw actuators are also heavier than pneumatic cylinders and require an electrical connection for operation.

The pneumatic cylinder 22 is located at the proximal end of the actuator member 20, which is typically where the operator would be grasping the window washing device 10 for support thereof. The pneumatic cylinder 22 has an inlet port 23 at the proximal end thereof, best seen in FIG. 8, for the introduction of compressed air into the pneumatic cylinder 22. Internally of the pneumatic cylinder 22 is the extendable rod 25 that has a base 26 that rests against the proximal fitting 24 housing the inlet port 23 at the proximal end of the pneumatic cylinder 22. The base 26 is sealed against the interior walls of the hollow actuator member 20 so that when compressed air is introduced into the inlet port 23, the base 26 slides through the hollow actuator member 20 to extend the rod 25 through the distal fitting 29 at the distal end of the pneumatic cylinder 22 until the base engages the distal fitting 29.

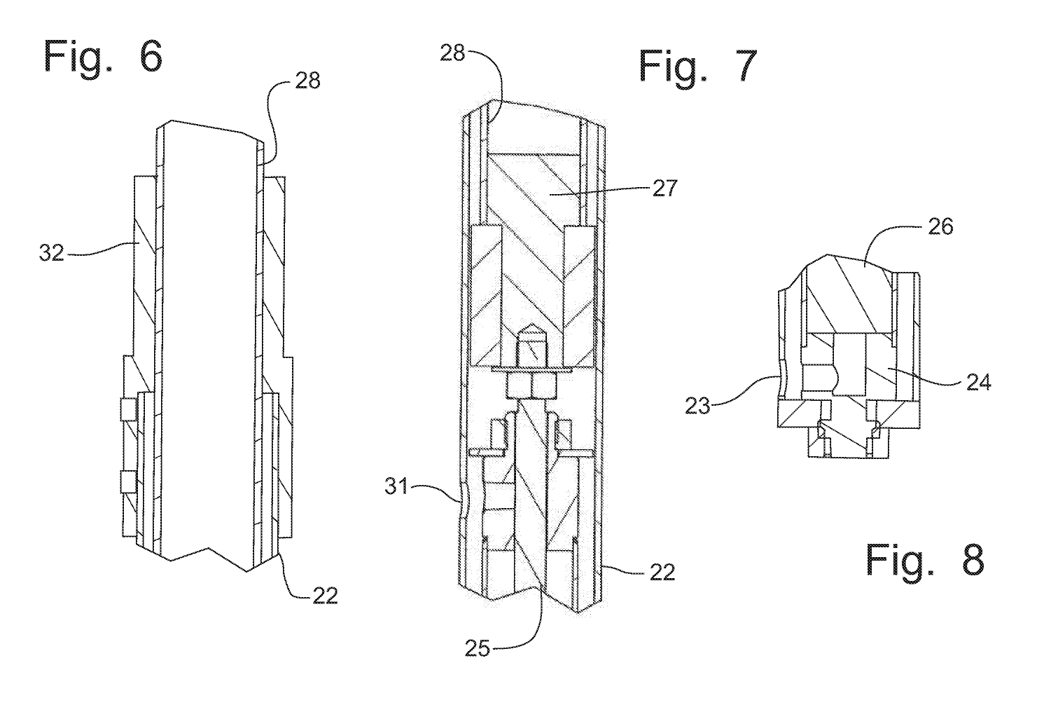

As best seen in FIGS. 4-6, the rod 25 is connected to the base 27 of an extendable tube 28 which is telescopically received within the hollow actuator member 20. Thus, whenever the rod 25 is extended, the extendable tube projects upwardly through the end adapter 32. With the handle 13 connected to the remote end of the extendable tube 28, the entire washing head 15 will move vertically upward corresponding to the stroke of the pneumatic cylinder 22.

To permit the rod 25, as well as the extendable tube 28 and the washing head 15, to retract, the source of compressed air connected to the inlet port 23 will be operated to reduce the pressure applied to the base 26 allowing the weight of the washing head 15 and handle 13 to push the base member 26 downwardly through the pneumatic cylinder 22 to the proximal fitting 24. Alternatively, the pneumatic cylinder could be configured to be double-acting, whereupon the distal fitting 29 would have an outlet port 31 through which air between the movable base 26 and the distal fitting 29 would escape when the base 26 moves toward the distal fitting 29. Then for retraction of the rod 25, the pressure would be reversed such that compressed air would be delivered to the distal fitting 29 and the air trapped between the base 26 and the proximal fitting 24 could escape through the lower fitting 23.

A repeated cycling of the extension and contraction of the pneumatic cylinder 22 will result in a vertical scrubbing movement of the washing head 15 when placed against the surface of the window to be cleaned. Preferably, the exterior surface of the pneumatic actuator 22 would have a control 35 mounted thereon for convenient access by the operator to control the movement of the air into and out of the pneumatic cylinder 22, and thereby control the scrubbing action of the washing head 15. The control mechanism 35 will also permit the operator to select different modes of operation, including, for example, the length of stroke of the washing head 15 during a scrubbing configuration, or the utilization of a squeegee device (not shown) that would provide an operative down stroke for the squeegee device.

In operation, the operator will connect the extendable tube 28 to the near end of the handle 13 with the washing head 15 positioned remotely therefrom. The length of the handle 13, or the number of modules connected together to form the handle 13, will depend on the height of the window to be cleaned. The operator will connect the supply line 17 to the supply of water, preferably pure water (deionized) which provides the best cleaning of remotely located windows, and to a supply of a cleaning solution that will be added to the water supply as needed for proper cleaning of the windows.

The inlet port 23 of the actuator member 20, and if a double acting cylinder is being utilized also the outlet port 31 at the distal end of the pneumatic cylinder 22, will be connected to a source of compressed air (not shown), preferably an air compressor that will provide a continuous supply of compressed air. The operator will control a switch (not shown) that will either operatively connect the inlet port 23 to the source of compressed air, and then disconnect the inlet port 23 from the source of compressed air, so that the single-acting pneumatic cylinder 22 will extend upwardly to an extended position and then retract downwardly into a retracted position due to the weight of the handle 13 and washing head 15 moving the rod 25 toward the inlet port 23. In this manner, the movement of the rod 25 between the retracted and extended positions creates a scrubbing motion for the washing head 15 against the surface of the window being washed. The preferably length of movement of the rod 25 between the retracted and extended positions is about two feet.

Preferably, the controller 35 will be provided that automatically controls the movement of compressed air into and out of the pneumatic cylinder 22 in a cyclical manner. In this configuration, the operator will need to turn a switch to activate the controller 35 to move the washing head 15 up and down in a reciprocal manner to provide the scrubbing action to the washing head 15 until the operator disengages the switch. Such a controller 35 would be operable with either the single-acting or double-acting pneumatic cylinder. For the double-acting pneumatic cylinder 22, the controller 35 would need, as an example, to operate a valve that switches the supply of compressed air between the inlet port 23 and the outlet port 31. In a squeegee operating mode, the controller 35 can be utilized to start the selected down stroke to move the properly placed squeegee downwardly along the window, and perhaps an automatic repositioning of the squeegee head before positioning for a subsequent down stroke operation. Such an operation to move a squeegee head can be accomplished with either the single-acting or double-acting air cylinder.

Once assembled and operating, the operator can move the washing head 15 from one window to the next while the washing head continues to cycle movement vertically against the surface of the window being cleaned. Once the job is completed, the supply of compressed air is deactivated, and the handle 13 is disconnected from the actuator member 20 and the entire washing device 10 can be disassembled and stored for transport to the next job site.

It will be understood that changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Having thus described the invention, what is claimed is:

1. A window washing device for cleaning a surface of a window, comprising:
a washing head adapted for engagement with said surface of said window;
an elongated handle connected to said washing head, said handle having a proximal end and a distal end, said washing head being mounted on said distal end; and
an actuator member connected to said proximal end of said elongated handle, said actuator member having a telescopic member and a linear actuator connected to said telescopic member and being operable to move said telescopic member in a reciprocal manner to provide a cyclical scrubbing movement for the washing head against the surface of the window being cleaned.

2. The window washing device of claim 2 wherein said linear actuator is a pneumatic cylinder comprising:
a sealed chamber extending between a proximal fitting and a distal fitting;
a rod having a base movable against interior walls of said sealed chamber;
an inlet port connectable to a source of compressed air to apply compressed air against said base at said proximal fitting to move said base toward said distal fitting, thereby causing said rod to move between a retracted position and an extended position; and
a control operable to control the application of compressed air to said inlet port such that said base is movable toward said distal fitting when said compressed air is applied to said inlet port and toward said proximal fitting when air is allowed to escape from said inlet port.

3. The window washing device of claim 2 wherein said linear actuator induces a reciprocal vertical movement to said washing head to scrub against said surface of said window.

4. The window washing device of claim 3 wherein said control provides a cyclical movement to said pneumatic cylinder without manual input from the operator.

5. The window washing device of claim 4 wherein said control operates a valve switching the flow of compressed air between said inlet port and an outlet port at said distal fitting to provide a powered movement of said rod between said extended and retracted positions.

6. The window washing device of claim 3 wherein said reciprocal vertical movement to said washing head includes a manually actuated down stroke.

7. The window washing device of claim 6 wherein said reciprocal vertical movement to said washing head includes an automatic return of said washing head to an extended position to enable proper positioning of said washing head prior to said manually actuated down stroke.

8. The window washing device of claim 1 wherein said actuator member is selectively detachable from said elongated handle.

9. An actuator for connection to a window washing device having a washing head and an elongated handle having a distal end connected to said washing head and a proximal end, comprising:
an actuator member incorporating a linear actuator that is movable in a reciprocal manner between a retracted position and an extended position, said handle being connected at said proximal end to said actuator member such that said handle and said washing head are moved in the reciprocal manner to provide a scrubbing motion to said washing head when placed against a surface of a window being cleaned.

10. The actuator of claim 9 wherein said linear actuator is a pneumatic cylinder operably connected to a source of compressed air.

11. The actuator of claim 10 wherein said pneumatic cylinder comprises:
a sealed chamber extending between a proximal fitting and a distal fitting;
a rod having a base movable against interior walls of said sealed chamber;
an inlet port connectable to a source of compressed air to apply compressed air against said base at said proximal fitting to move said base toward said distal fitting, thereby causing said rod to move between a retracted position and an extended position; and
a control operable to control the application of compressed air to said inlet port such that said base is movable toward said distal fitting when said compressed air is applied to said inlet port and toward said proximal fitting when air is allowed to escape from said inlet port.

12. The actuator of claim 11 wherein said control provides a cyclical movement to said pneumatic cylinder without manual input from the operator.

13. The actuator of claim 12 wherein said control operates a valve switching the flow of compressed air between said inlet port and an outlet port at said distal fitting to provide a powered movement of said rod between said extended and retracted positions.

14. The actuator of claim 11 wherein said control provides a manual mode of operation that when actuated moves the washing head through a single down stroke or predetermined length.

15. The actuator of claim 14 wherein said manual mode of operation automatically returns the washing head to an elevated position to permit proper positioning of the washing head prior to actuating the single down stroke.

16. A method of washing windows comprising the steps of:
connecting a washing head to a distal end of an elongated handle;
connecting a proximal end of said handle to a linear actuator;
operating said linear actuator in a manner inducing reciprocal movement to said washing head; and
placing said reciprocating washing head against a surface of said window being washed.

17. The method of claim 16 wherein said operating step comprises the steps of:
applying a source of compressed air to an inlet port at one end of said linear actuator to cause a rod of said linear actuator to extend;
releasing said inlet port from said source of compressed air to allow the weight of said washing head and said handle to move said rod to a retracted position; and
repeating said applying and releasing steps to create said reciprocal movement in said washing head.

18. The method of claim 16 wherein said operating step comprises the steps of:
applying a source of compressed air to an inlet port at one end of said linear actuator to cause a rod of said linear actuator to extend to an extended position; and
inputting a supply of compressed air to an outlet port at an opposing end of said linear actuator while releasing said inlet port from said source of compressed air to cause said rod to move to a retracted position.

19. The method of claim 16 further comprising the steps of:
controlling the operating step to conform to preselected modes of operation, including at least a cyclical step in which the operating step moves the washing head to provide a scrubbing action to the surface of the window, and a squeegee operating action in which the operating step moves through a down stroke at a manipulation by the operator.

20. The method of claim 19 wherein said controlling step can automatically return the washing head to an elevated position to allow proper positioning of said washing head prior to manipulating the operation of the down stroke.
